(19) United States
(12) Patent Application Publication
(10) Pub. No.: US 2010/0115570 A1
(43) Pub. Date: May 6, 2010

(54) Methods and Devices For Providing Dedicated Bandwidth On-Demand

(76) Inventors: Wilbur Howard Long, Bethesda, MD (US); Thomas Kevin Sullivan, Silver Spring, MD (US)

Correspondence Address: CAPITOL PATENT & TRADEMARK LAW FIRM, PLLC, P.O. BOX 1995, VIENNA, VA, 22183, US

(21) Appl. No.: 12/614,381

(22) Filed: Nov. 6, 2009

Related U.S. Application Data
(60) Provisional application No. 61/111,857, filed on Nov. 6, 2008.

(51) Int. Cl. H04N 7/173

(52) U.S. Cl. 725/110

(57) ABSTRACT

A media converter that includes a QAM modulator converts and maps packets within RF frequencies to 802.1q VLAN identifications (ID). Use of the media converter solves content delivery, bandwidth capacity issues and simplifies head end design.

### RELATED APPLICATION

This application is related to, and claims the benefit of priority from, U.S. Provisional Application No. 61/111,857 filed Nov. 6, 2008 the subject matter of which is incorporated in full herein as if it were set forth in full herein.

### BACKGROUND OF THE INVENTION

The cable TV industry (CATV) is running out of bandwidth on their existing hybrid fiber-coax (HFC) plant. Presently, all CATV services (e.g., television) are delivered to their customers using RF frequencies in the range of 0-1000 MHz. Originally, television services were delivered in an analog format/technology where a 6 MHz slot of bandwidth was consumed for each television channel delivered. All channels were sent simultaneously to all customers whether they were watching the channel or not. As new digital television formats/technologies became available, more channels were able to fit into each 6 MHz slot, thus increasing the amount of content multiple system operators (MSOs) were able to deliver to their customer base.

High speed data (HSD) has become a huge part of a cable operator's business. It has allowed the MSOs the ability to offer Voice over IP (VoIP) as well as Internet Protocol (IP) based video and data distribution. These services are delivered by a cable modem termination system (CMTS) in an MSO head end that sends data down one of the 6 Mhz channels to customer cable modems residing in hundreds of homes and/or businesses. This channel is referred to as a shared channel because bandwidth of approximately 38 Mb/s is shared among all of the customers, allowing every customer in the same service group to share a portion of this bandwidth. This unfortunately leads to congestion. Data integrity, security and access on the shared channel is provided by the Data Over Cable Service Interface Specification (DOCSIS) protocol running between the modem at the MSO head end and a modem at a particular customer premise.

There are other bandwidth challenges faced by cable operators. For example, with the advent of high definition television on top of VoIP and HSD, bandwidth requirements are skyrocketing. However, the 1000 Mhz of spectrum typically allocated remains static. In response, cable operators are splitting nodes in an attempt to service less customers on a given DOCSIS channel. They are deploying switched digital video to try and limit the amount of unused channels being sent to customers. Some are starting to deploy fiber to the home, which is a very costly endeavor.

### SUMMARY OF THE INVENTION

The inventors have discovered solutions to the bandwidth capacity issues described above as well as techniques that simplify overall head end design for content delivery. In one embodiment of the invention, this can be done using existing coaxial cables installed in each customer premise. In a further embodiment of the invention, a quadrature amplitude modulated (QAM) based media converter and set top box (STB) are provided. The media converter may be responsible for all control plane setup for video streams and their associated spectrum allocation. Complex signaling and control mechanisms are also provided between the STB and the media converter to deliver a program to a customer (i.e., customer's television). In yet a further embodiment of the invention, the HSD channel may be established by a separate set of hardware, the CMTS and the cable modem. This simplifies the back-end process by adding intelligence to the STB and combines IP/HSD functionality into one set of devices instead of a QAM modulator for video and a CMTS for IP data. The STB can become an IP gateway for all services for each customer.

In accordance with embodiments of the invention, portions of the RF spectrum may be dedicated to each individual customer premise as a dedicated carrier. In yet a further embodiment of the invention, this can be accomplished by giving the media converter and a home gateway the ability to tune to the same frequency range, so each customer will be given a discrete frequency range or bandwidth. This tuning capability may be granular to one hundredth of a MHz. This gives the cable operator the ability to deliver bandwidth to each customer on demand. If a customer needs more or less bandwidth the range can be tuned (i.e., adjusted) accordingly. This bandwidth may be used to deliver all services to a home and/or business. Further, if everything is IP based; voice, video and data may be sent using the same frequency carrier, and only when the customer requests it.

In still another embodiment of the invention, because the inventive techniques may be viewed as a complete IP based solution, information typically stored in a traditional modulator may be eliminated. Further, the inventive media converter is enabled to convert RF frequencies to 802.1q VLAN frames and visa-versa. An upstream interface on the media converter may be Ethernet based and can be standard gigabit or ten gigabit speeds. This interface may be configured as a VLAN trunk, which can connect to an IP router. This will give the STB the ability to request any IP service directly from the IP network. The media converter may also be designed to fit into an existing router chassis.

### BRIEF DESCRIPTION OF THE DRAWINGS

FIG. 1 is an example of RF frequency to VLAN mapping according to an embodiment of the invention.

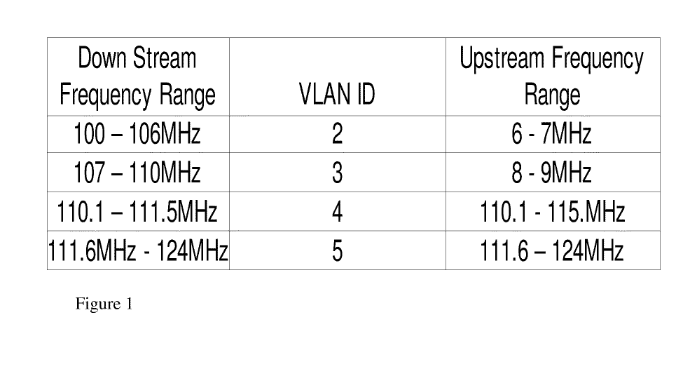

FIG. 2 is a simplified block diagram of a cable network from a customer's premise (e.g., home or business) to a CATV operator's head end according to an embodiment of the invention.

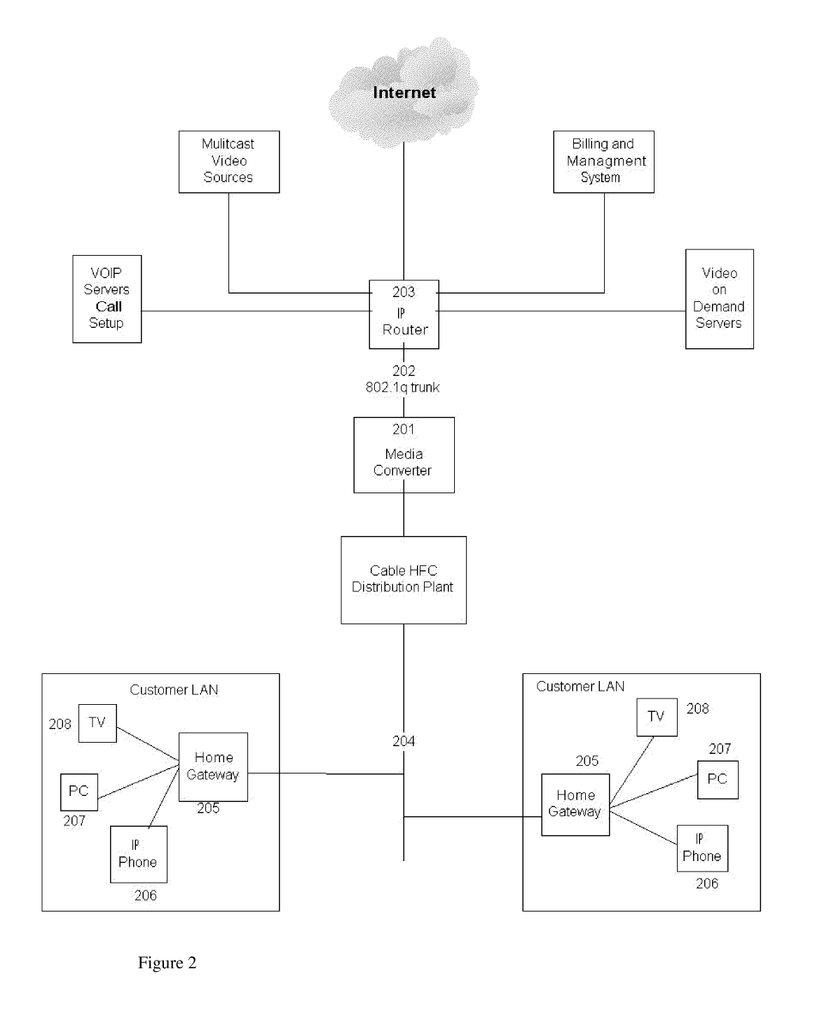

### DETAILED DESCRIPTION OF INVENTION

The techniques discovered by the inventors enable CATV operators to more efficiently utilize their HFC plant and gives them the ability to deliver dedicated bandwidth to each customer's premise in order to satisfy a particular customer's content delivery needs over the existing coaxial cable installed at each customer's premise. Instead of discrete systems dedicated to each type of service that a customer may request or that the CATV operator may wish to provide, multiple services can be provided using a novel, inventive platform (i.e., some combination of hardware, software and firmware). In accordance with one embodiment of the invention, such a platform may include a home gateway device 205 and an upstream media converter/modulator (hereafter “media converter”) 201. The platform may provide a full IP based solution when used in conjunction with an IP router 203 that is responsible for providing all services to a given home or business.

The media converter 201 may be located in a CATV head end and receive program requests from a customer's STB. In response, the media converter 201 may request programming information related to the customer's requests from upstream sources/systems and, upon receipt of the information from an upstream source, electronically insert (i.e., modulate) the information within a given time slot that is itself within a given frequency range and transmit the information to the STB. The information includes data that identifies a location (or locations) of a requested service. The STB may receive the information regarding the location of the requested service, tune to an associated frequency and send the program/content associated with the frequency/channel to the television set.

In accordance with additional embodiments of the invention, IP based high speed data communications and VoIP services can be removed from traditional DOCSIS channels and placed on a common RF channel dedicated to each customer. Further, because novel media converters operating in accordance with the present invention provide increased bandwidth to customers, DOCSIS based access rights and security functions are unnecessary.

Because RF to VLAN conversion is carried out by a novel QAM/media converter 201, all programming intelligence can be removed from the current QAM implementation. In accordance with embodiments of the invention, a media converter 201 may comprise a QAM based modulator to convert RF frequencies to 802.1q VLAN Ids. A home gateway 205 and the QAM modulator/media converter 201 may tune to the same frequency range to allow for dedicated bandwidth allocation to each customer premise. These devices may be tunable to one hundredth of a MHz. The media converter 201 may attach to an upstream IP router 203 via a gigabit or ten-gigabit Ethernet port, configured as an 802.1q trunk 202. The media converter 201 may be transparent (e.g., the communications, signaling and control information may now take place between an IP router 203, end systems and IP enabled devices within a customer's premise).

The current, downstream modulation scheme used by the RF-based plant of most cable operators is QAM 256. In comparison, upstream is dedicated to a lower portion of the spectrum and uses a QPSK modulation format. The techniques provided by the present invention are believed to be compatible with most cable operator's plants regardless of the modulation scheme used or in the event that the upstream and downstream channels are the same.

The present invention supports many IP based formats that may be offered by a cable operator, such as IPv4 or IPv6. Further, it is recognized that a particular transport IP format is transparent to the networking topology and or the applications running over them. A customer's local area network (LAN) may be part of the same subnet as the first hop cable operator router 203, or it may be internal to the customer premise with a centralized home gateway 205 communicating with the cable operator router 203. The RF frequency to VLAN translation may be the same regardless.

In accordance with embodiments of the invention, when an end user requests service an IP enabled device formats an IP packet with its own IP address in a source field and an end device IP address in a destination field. The so formatted IP packet may then be sent to a home gateway 205 for conversion into RF. The home gateway 205 then modulates the IP packet into the assigned RF frequency range. A novel media converter 201 may receive the IP packet on the RF frequency and map the packet to a VLAN ID. The media converter 201 may then send the data out on an 802.1q trunk 202 with the VLAN ID. A router 203 may then process an Ethernet frame and IP packet and send it to a remote destination for delivery to the user. When the data is delivered to the end user, a first hop router 203 will receive the data and send it out on a trunk with the appropriate header information. The media converter 201 may receive this information, strip the 802.1q header and modulate the underlying Ethernet frame into an appropriate frequency range. The home gateway 205 tuned to that frequency range may receive the data on an RF channel, convert it to Ethernet and forward the frame onto the customer LAN to the IP enabled user device.

I claim:

1. A media converter operable to:
receive program requests from a set-top box (STB);
request programming information related to a customer's requests from one or more upstream sources;
upon receipt of the information from the one or more upstream sources, insert the received information within a given time slot that is within a given frequency range; and
transmit the information to the STB.

2. The media converter as in claim 1 wherein the information includes data that identifies a location of a requested service.

3. The media converter as in claim 1 comprising a QAM modulator operable to convert packets within RF frequencies to 802.1q VLAN identifications (ID).

4. The media converter as in claim 3 wherein the QAM modulator is further operable to map an IP packet within an RF frequency to a VLAN ID.
